(19) United States
(12) Patent Application Publication
(10) Pub. No.: US 2020/0132210 A1
(43) Pub. Date: Apr. 30, 2020

(54) SOLENOID VALVE

(71) Applicant: FLUSHTECH CORPORATION, Taoyuan City (TW)

(72) Inventor: SUNG AN LAI, NEW TAIPEI CITY (TW)

(21) Appl. No.: 16/214,368

(22) Filed: Dec. 10, 2018

(30) Foreign Application Priority Data
Oct. 25, 2018 (TW) 107214521

(51) Int. Cl. F16K 31/06; F16K 31/40

(52) U.S. Cl. CPC F16K 31/0675; F16K 31/404

(57) ABSTRACT

A solenoid valve includes: a valve body with a valve seat therein; a sealing assembly provided on the valve seat; and a plunger to be driven by a solenoid to make the sealing assembly open or close the valve seat. The solenoid valve is characterized in that: a casing is coupled to the valve body and has an outer bottom portion protrudingly provided with a guide post; a flow channel is formed in the guide post; the sealing assembly includes a rigid disk, a flexible diaphragm, whose bottom side faces an orifice of the valve seat, and a central opening, in which the guide post is partially fitted; and the plunger has a bottom portion facing the inlet of the flow channel. With the guide post being stationary and linking the plunger and the sealing assembly, the solenoid valve features reduced power consumption and a low chance of solenoid failure.

### BACKGROUND OF THE INVENTION

### 1. Technical Field

The present invention relates to a solenoid valve and more particularly to a solenoid valve whose electromagnetic coil, or solenoid, can be activated less frequently than in the prior art to reduce power consumption by the solenoid valve.

### 2. Description of Related Art

FIG. 1 shows how a conventional servo-assisted, or pilot-operated, solenoid valve 10 works in order for a fluid 12 to flow from an inlet port 16 of a valve body 14 through a valve seat 18 of the valve body 14 to an outlet port 20. More specifically, a sealing assembly 22 is provided on the valve seat 18 to control passage of the fluid, and a plunger 24 is provided above the sealing assembly 22 to be driven into downward or upward movement by a solenoid 26. Once the plunger 24 is moved downward and pressed against the inlet of a flow channel 28 in the sealing assembly 22, the fluid can flow only into a chamber 30 above the sealing assembly 22, thereby moving the sealing assembly 22 downward until the sealing assembly 22 is pressed against the orifice of the valve seat 18, preventing the fluid from flowing through the valve seat 18 to the outlet port 20. Conversely, once the plunger 24 is moved upward and opens the inlet of the flow channel 28, the fluid in the chamber 30 will flow through the flow channel 28 toward the outlet port 20 such that the pressure in the chamber 30 becomes lower than the fluid pressure at the inlet port 16. As a result, the sealing assembly 22 is pushed upward and opens the orifice of the valve seat 18, allowing the fluid 12 to flow through the orifice of the valve seat 18 in large volume and exit by the outlet port.

The conventional solenoid valve described above is so designed that, when the plunger 24 is moved downward to prevent the fluid from passing through the valve seat 18, the sealing assembly is moved downward as soon as the plunger 24 is pressed against the inlet of the flow channel 28 in the sealing assembly 22 and thus keeps the fluid from flowing through the flow channel, but as the sealing assembly descends, the plunger must move downward along with the sealing assembly to keep the inlet of the flow channel blocked until a bottom portion of the sealing assembly seals the valve seat orifice completely. During the process, the solenoid must work incessantly in order to drive the plunger into displacement, and power consumption by the solenoid valve continues as a result. If the solenoid valve is powered by a battery, the service life of the battery and the interval between battery replacements will be reduced, which increases the cost of maintenance. Moreover, as continuous plunger movement requires the solenoid to be activated frequently, the failure rate of the solenoid may rise.

### BRIEF SUMMARY OF THE INVENTION

To overcome the aforesaid drawbacks of the conventional solenoid valves, the present invention provides a solenoid valve as described below. The solenoid valve of the present invention includes a valve body, a sealing assembly, and a plunger. The valve body has an inlet port, an outlet port, and a valve seat formed between the two ports. The sealing assembly is provided on the valve seat. The plunger is configured to be driven toward or away from a top portion of the sealing assembly by a solenoid in order to make the sealing assembly close or open the valve seat. The solenoid valve is characterized in that: a casing is coupled to the valve body and has an outer bottom portion protrudingly provided with a guide post, and a flow channel is formed in the guide post; the sealing assembly includes a rigid disk and a flexible diaphragm, the flexible diaphragm is coupled to the rigid disk and has a bottom side facing an orifice of the valve seat of the valve body, the guide post of the casing has a portion fitted in a central opening of the sealing assembly, and the sealing assembly can be moved vertically along an axis defined by the guide post; and the plunger has a bottom portion facing an inlet of the flow channel of the guide post of the casing.

Preferably, the rigid disk of the sealing assembly has a flanged engaging member that extends downward, the flanged engaging member passes through a central opening of the flexible diaphragm and couples the rigid disk and the flexible diaphragm together, and the guide post of the casing is fitted in a central opening of the rigid disk. Preferably, a sealing ring is mounted around the guide post of the casing and abuts against the wall of the central opening of the rigid disk.

Preferably, the flexible diaphragm of the sealing assembly has a nozzle that extends downward and a flanged engaging member that extends upward and corresponds in position to the nozzle, the flanged engaging member passes through a central opening of the rigid disk and couples the rigid disk and the flexible diaphragm together, and the guide post of the casing is fitted in a central opening of the flexible diaphragm. Preferably, the wall of the central opening of the flexible diaphragm is protrudingly provided with at least one sealing ring abutting against an outer portion of the guide post of the casing.

Preferably, the guide post includes a short ridge on the outer bottom portion of the casing and a long tube connected to the short ridge. Preferably, the short ridge is integrally formed with the casing or is fixedly coupled to the outer bottom portion of the casing, and the long tube is inserted in a space surrounded by the short ridge.

Preferably, the valve body is protrudingly provided with a ridge between the inlet port and the outlet port, and the casing is coupled to the valve body through the ridge.

Preferably, a spring is provided between the outer bottom portion of the casing and the top portion of the sealing assembly and is mounted around the guide post.

As the plunger and the sealing assembly are linked by the stationary guide post on the bottom side of the casing, the solenoid valve of the present invention is more energy-saving than its conventional counterparts, and the solenoid can be activated less frequently and therefore have a lower failure rate than in the prior art.

### BRIEF DESCRIPTION OF THE SEVERAL VIEWS OF THE DRAWINGS

The content of the present invention and the preferred modes of implementing the invention are detailed below with reference to at least one embodiment and the accompanying drawings, in which:

FIG. 1 is a sectional structural diagram of a conventional solenoid valve;

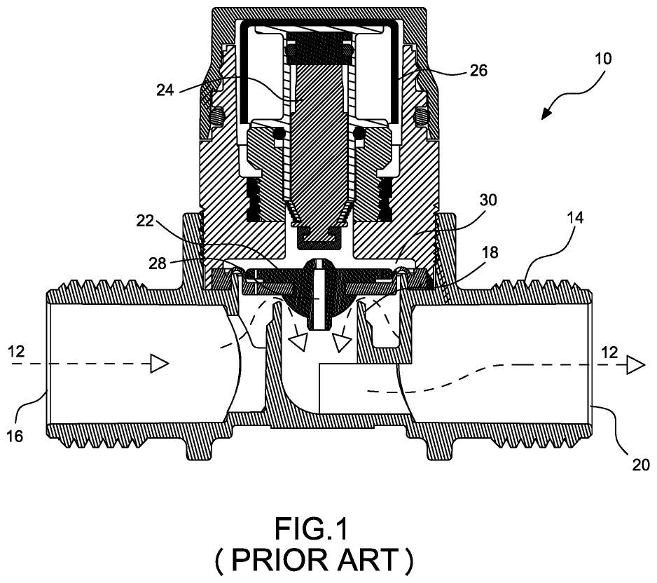

FIG. 2 is a sectional structural diagram of the solenoid valve according to the first embodiment of the present invention, showing the solenoid valve in a flow-blocking state;

FIG. 3 shows the solenoid valve in FIG. 2 in a flow-allowing state;

FIG. 4 is a sectional structural diagram of the solenoid valve according to the second embodiment of the present invention, showing the solenoid valve in a flow-blocking state; and

FIG. 5 is a partial enlarged view of FIG. 4.

### DETAILED DESCRIPTION OF THE INVENTION

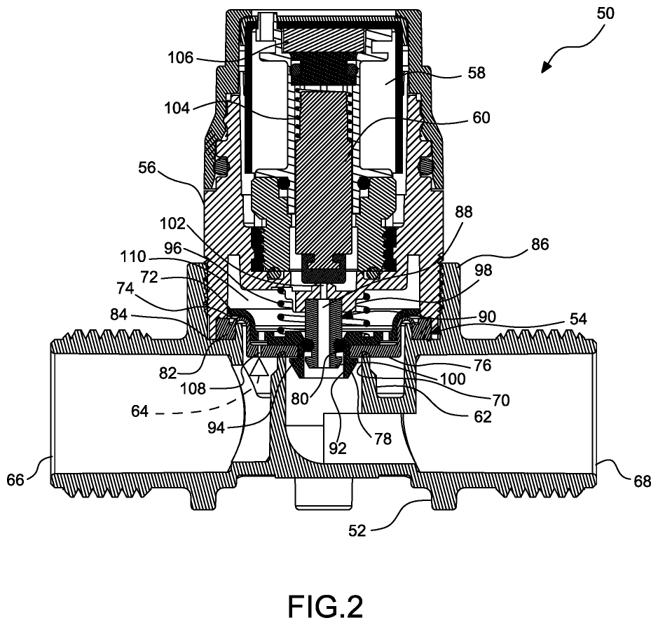

Referring to FIG. 2, the solenoid valve 50 according to the first preferred embodiment of the present invention includes: a valve body 52, a sealing assembly 54 provided in the valve body 52, a casing 56 provided on the valve body 52, a solenoid 58 provided in the casing 56, and a plunger 60 to be driven into upward/downward movement by the solenoid 58. By moving the plunger, the sealing assembly is driven to open or block a valve seat 62 of the valve body so that a fluid 64 is allowed or not allowed to enter an inlet port 66 of the valve body 52 and flow out of an outlet port 68 of the valve body through the valve seat 62.

In the solenoid valve 50 of the first preferred embodiment, the sealing assembly 54 is provided at an orifice 70 of the valve seat 62 of the valve body 52 and includes a rigid disk 72 and a flexible diaphragm 74. The flexible diaphragm 74 is coupled to the rigid disk 72 and has a bottom side 76 facing the orifice 70 of the valve seat 62. The rigid disk 72 of the sealing assembly 54 has a flanged engaging member 78 that extends downward. The flanged engaging member 78 extends through a central opening 80 of the flexible diaphragm 74 and couples the rigid disk 72 and the flexible diaphragm 74 together. The peripheral edge 82 of the flexible diaphragm 74 is held down by the bottom edge of the casing 56 and thus fixed in an annular groove 84 of the valve body 52.

In the solenoid valve 50 of the first preferred embodiment, the casing 56 is coupled to, and located in the space surrounded by, a ridge 86 on the valve body 52. A bottom portion of the casing 56 is protrudingly provided with a guide post 90. A flow channel 88 is formed in the guide post 90. A portion of the guide post 90 is fitted in a central opening 92 of the rigid disk 72 of the sealing assembly 54. A sealing ring 94 is mounted around the guide post 90 and abuts against the wall of the central opening 92 of the rigid disk 72. A spring 96 is also mounted around the guide post 90 and is located between the bottom side of the casing 56 and the top side of the rigid disk 72.

The guide post 90 of the first preferred embodiment includes a short ridge 98 formed on the bottom portion of the casing 56 and a long tube 100 provided at a bottom portion of the short ridge. The short ridge 98 is integrally formed with the casing 56. The long tube 100 is inserted in the space surrounded by the short ridge 98. The flow channel in the guide post 90 includes a relatively small-diameter passageway surrounded by the short ridge and a relatively large-diameter passageway in the long tube, wherein the two passageways are in communication with each other. The upper end of the relatively small-diameter passageway forms a protruding inlet 102. A bottom portion of the plunger 60 faces the protruding inlet 102. A spring 104 is mounted around a top portion of the plunger 60 and is spaced apart from a permanent magnet 106.

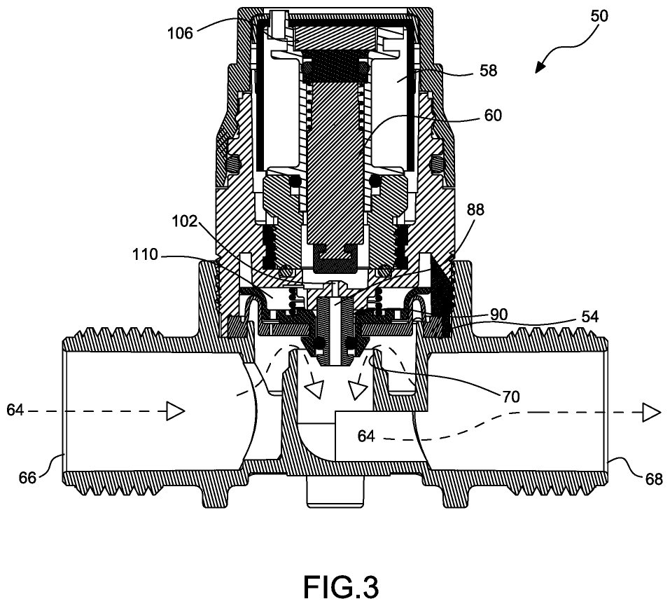

The solenoid valve 50 can be brought into a flow-blocking state in the following manner. Referring to FIG. 2, the plunger 60 is driven downward by the solenoid 58 and the spring 104 at the upper end of the plunger such that the bottom end of the plunger is pressed against the protruding inlet 102 of the guide post 90. Consequently, the fluid 64 enters the inlet portion 66 of the valve body 52 and flows into a chamber 110 between the rigid disk 72 and the bottom side of the casing 56 through an injection channel 108 of the sealing assembly 54. Once the chamber 110 is filled up by the fluid, the sealing assembly 54 is pushed downward by the fluid in the chamber and is pressed against the orifice 70 of the valve seat of the valve body, preventing the fluid from flowing out of the outlet port 68; thus, the solenoid valve enters the flow-blocking state. To bring the solenoid valve into a flow-allowing state, referring to FIG. 3, the plunger 60 is driven upward by the solenoid 58 and is temporarily secured in position by magnetic attraction to the permanent magnet 106, with the bottom portion of the plunger 60 moved away from the protruding inlet 102 at the top end of the guide post 90. The fluid 64, therefore, flows toward the outlet port 68 of the valve body through the flow channel 88 in the guide post 90, creating a change in pressure in the chamber 110. When the pressure in the chamber is lower than the pressure at the inlet port 66 of the valve body, the sealing assembly 54 is pushed upward and hence no longer blocks the orifice 70 of the valve seat. The fluid can now enter the inlet port 66 of the valve body, flow through the orifice 70 of the valve seat, and exit the output port 68 of the valve body in large volume. When a preset amount of the fluid has been output, the solenoid 58 drives the plunger 60 downward again in order to press the bottom end of the plunger against the protruding inlet 102 at the top end of the guide post. The chamber 110 will be filled up with the fluid again, pushing the sealing assembly 54 downward until the orifice 70 of the valve seat is resealed to prevent the fluid from flowing out of the outlet port 68 of the valve body.

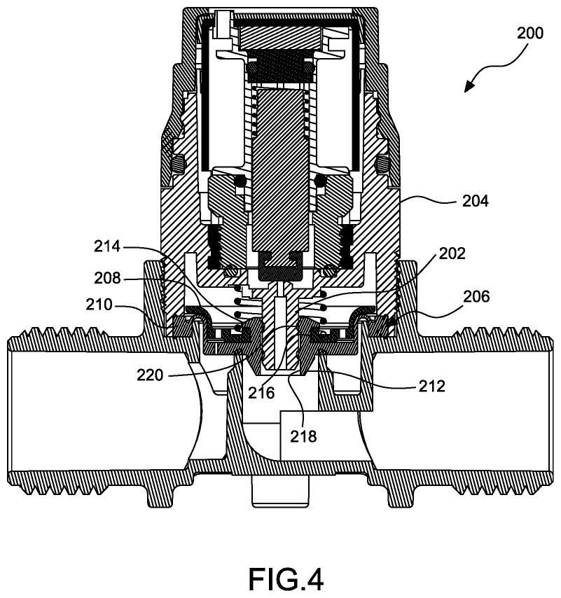

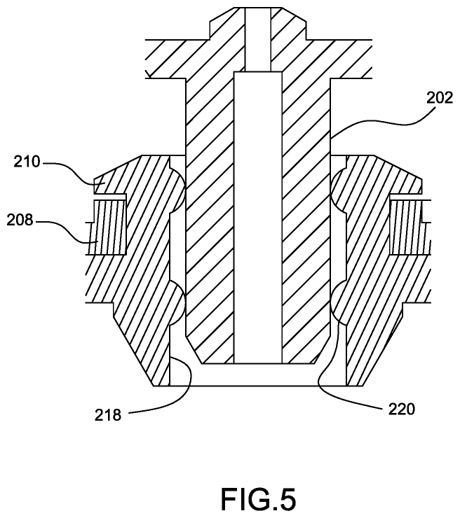

FIG. 4 and FIG. 5 show the solenoid valve 200 according to the second preferred embodiment of the present invention. The solenoid valve 200 is different from the solenoid valve 50 of the first preferred embodiment in that the entire guide post 202 in the solenoid valve 200 of the second preferred embodiment is integrally formed with the casing 204; that although the sealing assembly 206 in the solenoid valve 200 of the second preferred embodiment also includes a rigid disk 208 and a flexible diaphragm 210 coupled to the rigid disk 208, the flexible diaphragm 210 of the sealing assembly 206 has a downwardly extending nozzle 212 and an upwardly extending flanged engaging member 214 corresponding in position to the nozzle, wherein the flanged engaging member 214 extends through a central opening 216 of the rigid disk 208 and couples the rigid disk 208 and the flexible diaphragm 210 together; and that the guide post 202 is partially inserted in a central opening 218 of the flexible diaphragm 210, wherein the wall of the central opening 218 is protrudingly provided with at least one sealing ring 220 abutting against an outer portion of the guide post 202.

While the guide posts 90, 202 in the solenoid valves 50, 200 of the first and the second preferred embodiments are respectively integrally formed with the casings 56, 204 either partially or entirely, it is feasible for the guide post in another embodiment to be fixedly coupled to the casing by any applicable means.

The solenoid valves 50, 200 have the following features. Given that the guide post is integrally formed (or fixedly coupled to) the bottom side of the casing, that the sealing assembly is configured for vertical movement along an axis defined by the guide post, and that the guide post is fixed in position and will not move when the sealing assembly is moved, the distance for which the plunger is required to be driven by the solenoid to block the protruding inlet of the guide post and thereby bring the solenoid valve into the flow-blocking state is constant, which means that power consumption by the solenoid is constant. Once the protruding inlet is blocked, the sealing assembly can seal the valve seat orifice and thus produce a flow-blocking effect solely by means of pressure variation in the chamber, without consuming any electricity. The solenoid valves 50, 200, therefore, are more energy-saving than their conventional counterparts. Furthermore, the solenoid in each of the solenoid valves 50, 200 need not be activated frequently while the sealing assembly is moved downward, as is the case in the prior art, but is activated only when it is required to press the plunger against the protruding inlet of the guide post. Thus, the number of times for which the solenoid is activated, and consequently the chance of failure of the solenoid, are reduced.

The embodiments described above serve only to demonstrate the preferred modes of implementation, but not to restrict the scope, of the present invention. A person of ordinary skill in the art may change or modify those embodiments based on the technical content disclosed herein without departing from the technical concept of the invention. The scope of patent protection sought by the applicant is defined by the appended claims.

What is claimed is:

1. A solenoid valve, comprising: a valve body having an inlet port, an outlet port, and a valve seat formed between the two ports; a sealing assembly provided on the valve seat; and a plunger configured to be driven toward or away from a top portion of the sealing assembly by a solenoid in order to make the sealing assembly close or open the valve seat; the solenoid valve being characterized in that:
a casing is coupled to the valve body, the casing has an outer bottom portion protrudingly provided with a guide post, and the guide post is formed therein with a flow channel;
the sealing assembly comprises a rigid disk and a flexible diaphragm, the flexible diaphragm is coupled to the rigid disk and has a bottom side facing an orifice of the valve seat of the valve body, the guide post of the casing has a portion fitted in a central opening of the sealing assembly, and the sealing assembly is vertically movable along an axis defined by the guide post; and
the plunger has a bottom portion facing an inlet of the flow channel of the guide post of the casing.

2. The solenoid valve of claim 1, wherein the rigid disk of the sealing assembly has a downwardly extending flanged engaging member, the flanged engaging member extends through a central opening of the flexible diaphragm and couples the rigid disk and the flexible diaphragm together, and the guide post of the casing is fitted in a central opening of the rigid disk.

3. The solenoid valve of claim 2, further comprising a sealing ring mounted around the guide post of the casing and abutting against a wall of the central opening of the rigid disk.

4. The solenoid valve of claim 1, wherein the flexible diaphragm of the sealing assembly has a downwardly extending nozzle and an upwardly extending flanged engaging member corresponding in position to the nozzle, the flanged engaging member extends through a central opening of the rigid disk and couples the rigid disk and the flexible diaphragm together, and the guide post of the casing is fitted in a central opening of the flexible diaphragm.

5. The solenoid valve of claim 4, wherein the central opening of the flexible diaphragm has a wall protrudingly provided with at least one sealing ring abutting against an outer portion of the guide post of the casing.

6. The solenoid valve of claim 1, wherein the guide post comprises a short ridge on the outer bottom portion of the casing and a long tube connected to the short ridge.

7. The solenoid valve of claim 6, wherein the short ridge is integrally formed with the casing, and the long tube is inserted in a space surrounded by the short ridge.

8. The solenoid valve of claim 6, wherein the short ridge is fixedly coupled to the outer bottom portion of the casing, and the long tube is inserted in a space surrounded by the short ridge.

9. The solenoid valve of claim 1, where the valve body is protrudingly provided with a ridge between the inlet port and the outlet port, and the casing is coupled to the valve body via the ridge.

10. The solenoid valve of claim 1, further comprising a spring provided between the outer bottom portion of the casing and the top portion of the sealing assembly and mounted around the guide post.
